(19) United States
(12) Patent Application Publication
(10) Pub. No.: US 2012/0111854 A1
(43) Pub. Date: May 10, 2012

(54) DEVICE FOR INDUCTION HEATING

(76) Inventor: Jean-Yves Gaspard, Gleize (FR)

(21) Appl. No.: 13/348,701

(22) Filed: Jan. 12, 2012

Related U.S. Application Data
(63) Continuation of application No. PCT/FR2010/051466, filed on Jul. 12, 2010.

(30) Foreign Application Priority Data
Jul. 17, 2009 (FR) 0954959

(51) Int. Cl. H05B 6/06; H05B 6/02

(52) U.S. Cl. 219/650; 219/647

(57) ABSTRACT

An induction heating device includes at least one base having at least one heating area, and at least one inductor arranged under the base opposite the heating area. The base includes a recess delimiting the heating area and inside which a support is arranged partially covering the heating area and partially secured to the base, the support being able to support a receptacle so as to hold the receptacle above the recess.

### CROSS-REFERENCE TO RELATED APPLICATIONS

The present application is a continuation of pending International Patent Application PCT/FR2010/051466, filed on Jul. 12, 2010, which designates the United States and claims priority from French Patent Application 0954959, filed on Jul. 17, 2009, the content of which is incorporated herein by reference.

### FIELD OF THE INVENTION

The present invention relates to the field of devices for cooking by induction, commonly referred to as “induction plates” or “induction hobs”.

### BACKGROUND OF THE INVENTION

In general terms, and with reference to FIGS. 1 and 2, an induction heating device 1 comprising in particular a base 10 forming a flat surface, generally made from non-magnetic electrically insulating material resistant to high temperatures, such as vitroceramic glass, commonly referred to as vitroceramic, intended to support a receptacle 3 suitable for induction cooking. The base 10 has a heating area 11 (or cooking hotplate) under which an induction coil 2 (or inductor) is arranged, placed in a casing 13 (or frame), generally produced from sheet steel, supporting the base 10. The induction coil 2, supplied by an alternating current generator, creates a variable electromagnetic field in the receptacle 3, with a preferably ferromagnetic base, placed in the heating area 11. Eddy currents appear and produce heating of the receptacle 3 by Joule effect, and heating of the food contained in the receptacle 3 by thermal conduction.

Although the receptacle is heated by means of an electromagnetic field, the energy efficiency is not yet optimal. This is because not all the heat is transmitted to the food contained in the receptacles since, because the surface of the bottom of the receptacles is in contact with the surface portion of the base forming the heating area, some of the heat from the receptacle is lost by thermal conduction over this vitroceramic surface portion forming the heating area.

This area is therefore heated by contact of the receptacle and for reasons of safety the manufacturers warn the user of the temperature of the vitroceramic by residual heat indicators, since the heating area remains hot for a long time when the receptacle is removed.

The air gap of the magnetic circuit formed by the magnetic circuit of the induction coil and the receptacle placed at the heating area is mainly defined by the thickness of the vitroceramic base, the thickness of which is around 4 to 5 millimetres, to which it is necessary to add the thickness of a heat insulator interposed between the inductor and the base, intended to protect the inductor from high temperatures. The air gap is thus typically around 5 to 8 millimetres. The dimensions of this air gap require the use of a coil containing more turns or more magnetic circuit in order to achieve suitable impedance characteristics, which increases not only the manufacturing cost since producing the inductor requires more conductive or magnetic material, but also causes the appearance of magnetic field leakages in the air gap.

Reducing the dimensions of the air gap does however prove difficult to achieve. This is because the vitroceramic base must be sufficiently strong to support the weight of ferromagnetic receptacles and any impacts. However, a reduction in the thickness of the vitroceramic base would impair the mechanical strength of the base and would not make it possible to produce wide hobs or ones intended for professionals, or even of standard dimensions.

In addition, since the heating temperature may reach high values, reducing the thickness of the vitroceramic plate and that of the heat insulator would not make it possible to ensure good thermal insulation of the inductor.

Another drawback of this type of solution is that it is difficult to measure the temperature of the receptacle precisely, in particular because of the thickness of the base. This is because the temperature is measured by means of a temperature sensor generally placed under the vitroceramic base. Because of the thickness of the vitroceramic, direct measurement of the temperature of the receptacle by the temperature sensor remains very approximate, or even inaccurate.

Because of this poor measurement of the temperature of the receptacle, the receptacles have a tendency to be overheated at temperatures that may achieve 500° C., or even more, whereas the maximum cooking temperature actually necessary is only around 250° C. Firstly, this overheating damages some receptacles by causing in particular a concave deformation of the bottom of these receptacles when the temperature rises, and secondly use of the receptacle having a deformed bottom makes the temperature measurement even more inaccurate.

The document EP 1 017 256 proposes a solution for measuring the temperature of the receptacle being heated, in particular by introducing a sensitive element of the sensor in contact with the bottom of the receptacle. The sensitive element, arranged in a hole passing through the vitroceramic base, must be of reduced size in order to prevent any excessive heat dissipation. This solution is however not suited to receptacles having concave deformations since the sensitive element does not afford a good measurement of the temperature when the bottom of the receptacle is deformed and is no longer in direct contact with the support. In addition, producing a through hole in the vitroceramic base weakens the mechanical strength and poses problems of sealing that are expensive to solve.

An improvement in the measurement of the temperature can also be achieved by including measuring systems taking account of deformations of the receptacles and inaccuracies due to the thickness of the vitroceramic, but these measuring systems are however complex and expensive.

Moreover, although vitroceramic has the advantage of being resistant to high temperatures, this material remains expensive and sensitive to impacts and abrasions.

There is therefore an interest in finding a solution making it possible in particular, not only to limit the heat losses, but also to provide a good measurement of the temperature in order to optimise efficiency, while using materials that are less expensive and resistant to impacts and abrasions.

In this context, the purpose of the present invention is to propose an induction cooking device free from at least one of the limitations mentioned above. One objective of the invention is in particular to propose an induction cooking device having a flat plate made for a material other than vitroceramic, resistant to high temperatures, but also to impacts and abrasions, without risk for the user. Another objective of the invention is to improve the energy efficiency, but also the measurement of the temperature of the receptacles.

### SUMMARY OF THE INVENTION

The subject matter of the invention is thus an induction heating device comprising at least one base having at least one heating area, and at least one inductor arranged under the base opposite the heating area.

According to the invention, the base comprises a recess delimiting the heating area, and inside which a support is arranged partially covering the said heating area and partially secured to the base, the said support being able to form the contact area that supports a receptacle, so as to hold the said receptacle above the recess.

In other words, unlike the prior art where the surface of the support intended to support the receptacle extends over the entire surface of the bottom of the receptacle, the invention proposes to reduce the surface of the said support. This reduction of the surface of the support in particular limits the contact surface of the receptacle with the support and therefore reduces the heat losses from the receptacle by thermal conduction, while ensuring stable holding of the receptacle. This solution also has the advantage of allowing the use, for the base and for the support, of materials other than vitroceramic, preferably resistant to impacts, abrasions and high temperatures.

Advantageously, the base and support are made from metal material, preferably resistant to impacts, abrasions and high temperatures, for example made from austenitic stainless steel. The base may be connected to a reference potential, such as the earth.

Thus, according to this particular embodiment, the elements liable to be in direct contact with the receptacle, such as the base and the support, and therefore liable to be touched by a user, are produced from metal materials, unlike the solutions of the prior art which, for safety reasons, do not allow these elements, base and support, to be metal.

Indeed, it is unimaginable for a person skilled in the art to replace the vitroceramic plate used for the induction heating devices of the prior art with a metal plate. Firstly, high induced currents would flow in the metal plate, causing significant heating of the metal plate, dangerous for the user, and secondly the receptacle placed on this plate would be heated not by induction but by transfer of the heat from the metal plate, which is contrary to the effect sought for induction heating.

Conversely, this particular embodiment of the invention offers the possibility of using a base and support made from metal materials. Since the support only partially covers the heating area and may be cut so as to minimise the appearance of induced currents, heating thereof by induction is very limited. In addition, since the support has only a portion in contact with the base, the heat transfers between the receptacle, the support and the base are also limited.

In addition, in the conventional solutions, the inductor and the receptacle placed on the heating area form an electrical capacitor. When the inductor is supplied, the receptacle charges up electrically, and a small leakage current is liable to pass through the body of a person touching the receptacle. The solution proposed in this particular embodiment solves this problem. This is because, in the case in particular of an uncoated receptacle (for example not enamelled), the support and base being made from metal and therefore conductive material, and the support having a portion in contact with the base, the receptacle is thus electrically connected to earth, thereby protecting the user from current leakages.

In the case where the inductor has a sufficiently strong top surface, the support may be placed directly on the said top surface of the inductor. In this particular embodiment, the sealing of the assembly formed by the surface of the inductor, the support and the base may be achieved by means of a gasket. This seal may be achieved by a conventional method, such as the one used in the prior art for producing the seal between a vitroceramic plate and a steel frame.

Advantageously, it is also possible to provide a plate made from non-magnetic electrically insulating material extending over the entire heating area and on which the said support can rest. The plate may also be moulded onto the support. This technique also makes it possible to produce diverse shapes for conferring on the non-magnetic plate other functions such as the support for the inductor system, temperature measurement devices, or even the assembly consisting of the inductor and the associated electronic system.

In other words, the recess defining the heating area comprises a plate made from non-magnetic electrically insulating material on which the support is arranged. This non-magnetic electrically insulating plate protects and isolates the inductor while allowing the electromagnetic field to pass through. The support placed on this non-magnetic electrically insulating plate holds the receptacle above the recess and prevents any contact of the receptacle with the non-magnetic electrically insulating plate. It is therefore possible to use, for producing the non-magnetic electrically insulating plate, a material having less mechanical strength, namely less resistant to impacts and abrasions, for example made from stoneware, ceramic, plastic, mica or mica-glass alloy, glass cloth impregnated with silicone or glass, which are generally lower-cost materials. Moreover, this solution allows use of material of varied colours. In addition, this embodiment offers the possibility of using a non-magnetic electrically insulating plate of reduced thickness, for example less than or equal to 5 millimetres, and consequently makes it possible to reduce the air gap in the magnetic circuit formed by the inductor and the receptacle, and therefore makes it possible to produce inductor systems with lower losses, while reducing the cost thereof. This is because, if the dimensions of the air gap are reduced, it is possible to use inductors containing fewer turns for achieving suitable impedance characteristics, which makes it possible to reduce the manufacturing cost, as well as the electromagnetic leakages.

According to one embodiment, the device also comprises at least one temperature sensor, the sensitive part of which is in contact with the support.

The temperature sensor is preferably arranged opposite the centre of the support.

This embodiment offers the possibility of measuring the temperature of the receptacle more precisely, in particular when the support is produced from metal material.

According to a particular embodiment, the non-magnetic electrically insulating plate has at least one recess in which at least one temperature sensor is arranged, the sensitive part of which is in contact with the support.

In this embodiment, since the non-magnetic electrically insulating plate does not undergo any significant mechanical stresses, it is possible to provide a recess, for example a hole passing through the non-magnetic electrically insulating plate, in order to house the temperature sensor therein. This embodiment has the advantage of making it possible to place the temperature sensor as close as possible to the support and ideally in contact with the latter, thus improving the measurement of the temperature of the receptacle.

The temperature sensor can also be arranged in the non-magnetic electrically insulating plate in contact with the support by overmoulding.

According to a particular embodiment, the support is in the shape of a star having a plurality of arms, the free end of at least one of the said arms being secured to the base.

This particular form offers the advantage of enabling the support to hold the receptacle stable above the recess while limiting the support surface with the receptacle, and thus reducing the heat transfers by thermal conduction.

In addition, during heating, the surface of the bottom of the receptacle in contact with the support generally decreases since the bottom of the receptacle deforms during heating. A temperature sensor at one point, arranged for example at the centre of the support, therefore thereby delivers erroneous measurements. The particular form of the support proposed above firstly enables the receptacle, even having a deformed bottom, to be continuously in contact with the support at all the arms thereof, and secondly enables the heat transmitted by the receptacle to the support to be distributed evenly over the thermally conductive support, making the measurement of the temperature much more precise.

A more precise measurement of the temperature of the receptacle affords better temperature regulation, which makes it possible firstly to optimise the heating capacity and secondly to reduce the maximum temperatures to be provided, which makes it possible to use material withstanding lower maximum temperatures (for example 250° C. instead of 500° C.).

The contact surface between the support with a special shape and the receptacle being much less, the thermal efficiency is much better. In addition, the thermal regulation via the temperature sensor that measures the temperature of the receptacle more precisely prevents the latter from overheating. This affords greater safety in operation. Firstly the heating temperature can be limited to the temperature necessary for cooking, for example thereby preventing ignition of oil films, secondly the temperature of the support can be greatly limited when the receptacle is removed, allowing more rapid cooling of the support because of its lower thermal inertia.

The induction heating device can also comprise a visual device dependent on the temperature of the support. For example, it is possible to apply locally to the support a device indicating the temperature, such as a phase-change ink, making it possible to view whether the support is at a given temperature, for example still too hot to be cleaned or simply touched.

For example, the support has at least one first cruciform portion, the free end of at least one of the arms of the said portion being secured to the base.

The support can also have at least second and third portions in the form of an arc of a circle, arranged opposite each other symmetrically with respect to at least one of the arms or the said first portion.

According to a particular embodiment, the support is in the form of a star, the profile of each arm of the said support having a top base intended to be in contact with the receptacle and a bottom base opposite the said top base, the said top base having a length less than that of the bottom base.

According to another particular embodiment, the support can consist of a main base and a multitude of arms, the number and width of which are optimised to minimise the magnetic coupling to the inductor system while fulfilling a role of stable support and a role of capturing the temperature of the load, in contact with this support. For example, the support can be in the shape of a fir tree.

These profiles, described by way of non-limitative examples, have in particular the advantage of reducing the contact surface of the support with the receptacle in order to limit the heat transfers while offering secure and stable holding of the receptacle.

In general terms, the geometry of the support can be the result of a compromise between:
a sufficient surface to hold the receptacle above the recess, so that the smallest receptacle useable does not touch the non-magnetic electrically insulating plate, even if the bottom of the receptacle has deformations;
a cut surface having a minimum of coupling with the inducing magnetic field in order to prevent the support being subject to excessive induced currents;
a minimum contact surface for limiting heat exchanges with the receptacle; and
an optimised surface and thermal inertia for ensuring optimum thermal transfer to the temperature sensor that is associated therewith.

Moreover, the inductor system can be provided with a magnetic circuit. The sizing of this magnetic circuit, in particular its shape, can be optimised in order to reduce the coupling of the cut surface of the support with the inductor system, for example by increasing the magnetic flux in the areas where the support is absent, while avoiding directing this flux into the areas where the support is situated.

If a special shape of the support has an advantage, the minimisation of the losses by induced currents in this special shape may be considered to be secondary. This is because these losses are generated not below the non-magnetic electrically insulating plate but above, and therefore participate potentially in the heating of the load, and therefore in the efficiency.

Advantageously, the thickness formed by that of the non-magnetic electrically insulating plate combined with that of the support is less than or equal to five millimetres.

The borders of the base can also form the casing of the global heating device.

The device may also comprise a system for regulating the temperature of the receptacle.

According to another embodiment, the heating device can also comprise a weight measurement module, such as for example a piezoelectric sensor associated with a signal acquisition and processing module. The piezoelectric sensor can be disposed close to the temperature sensor between the support and the insulating plate. The support can be secured to the insulating plate by means of a temperature-resistant gasket, such as for example a silicone gasket, allowing sufficient lowering of the support so as to act on the piezoelectric sensor in particular when a receptacle is placed on the support. Naturally, the weight measurement module can be arranged in another way in the device, provided that there exists a rigid mechanical connection (for example a shaft) able to transmit any mechanical deformation of the support to the weight measurement module.

In this embodiment, it is thus possible to weigh the receptacle placed in the support but also the content of the receptacle, in particular after taring. In addition, this embodiment offers in particular the possibility of providing the heating device with additional functions such as for example automatic cooking. This “automatic cooking” function can result in the automatic stoppage of the cooking when the weight detector is below a threshold value representing the evaporation of a certain quantity of liquid.

In addition, this weighing function can also be used for regulating and protecting the heating system by preventing for example associating excessively high powers with excessively light receptacles. In the case for example of the heating of receptacles formed from non-magnetic material that are subjected to a high repulsion force according to the power, prior knowledge of the weight of the utensil to be heated then makes it possible to limit the maximum power to values below the value at which the utensil could be ejected from the inductor system. The weighing function can also be used for detecting receptacles placed on the hotplate, in addition to or in substitution for the systems for detecting the presence of a receptacle based on the principle of the impedance of the inductor system.

Thus, unlike the induction heating systems of the prior art in which the vitroceramic glass support could not be pierced without being weakened and was solely flat, use of the metallic base allows various shapes, in particular non-flat, produced for example by pressing. For example, the metal base can have, with regard to some hotplates, special shapes and dimensions such as limits or rims, or a shape adapted for the use of specific utensils, such as for example a wok. It is thus possible to form the metal base so as to produce a work surface comprising not only conventional induction cooking hobs or ones having a particular shape, but also reliefs or placements intended to hold or receive accessories as well as the control system thereof. Motorised accessories of the mixer type can for example be envisaged, or those that are purely resistive, of the grill type using elements or infrared, or the like, which could be fixed firmly in the environment of the hotplates in order to allow different work on the preparation during heating. These accessories can be supplied by protected sockets produced in the base or be directly supplied by an inductor temporarily unused for heating. In the latter case, the control cycles of these systems can be controlled from a control module of the induction system, which would then manage not only the heating and/or weighing function but also various related mixing, chopping or stirring functions driven by the control of the system according to the demands of the user or predefined recipes including particular operating sequences of the various components of the system according also to the temperature and weight information available continuously.

In the embodiments presented above, the recess combined with shape of the support for a receptacle to be heated may form nooks in which dirt may be encrusted, making it less easy to clean the heating device.

Thus, in another embodiment, the induction heating device may comprise at least one:
inductor defining a heating area;
support for a receptacle disposed vertically in line with the inductor; and
a non-magnetic electrically insulating plate arranged between the support and the inductor, the support being able to rest on the said insulating plate.

In other words, in this other embodiment, there is no longer any recess around the support, the support for a receptacle being arranged on the insulating plate. The nooks in which dirt may be encrusted are therefore reduced, which facilitates cleaning. The insulating plate may therefore extend beyond the heating area so as to constitute for example a work surface for the user.

The insulating plate can be produced from a material having a good compromise between good mechanical strength and a lower cost. For example, the insulating plate may be made from mica, reinforced glass or a mica-glass alloy.

The support for a receptacle may have a cruciform shape or any other shape affording for example easy cleaning, stability of the receptacle and a reduced contact surface with the receptacle.

The support can also be made from metal material, preferably resistant to impacts, abrasions and high temperatures, for example made from austenitic stainless steel. The metal support can be connected to a reference potential, such as the earth, for the same reasons as disclosed above.

The support may be fixed to the insulating plate removably via a fixing system integrated in the insulating plate and in cooperation with the support. For example, the system may be such that it is possible to fix the support to the insulating plate, to remove the support or to turn the support. The fixing system may also constitute part of the rigid mechanical connection able to transmit any mechanical deformation of the support to the weight measurement module.

In addition, the heating device may include a vibrating system able to confer a low-amplitude movement on the support and therefore on the receptacle placed on this support, to prevent for example the food contained in this receptacle from adhering to the internal wall of the receptacle. For example, this vibrating system may comprise an electromagnet or a vibrator. Naturally it is preferable to protect the placing of the receptacle on the support in order to prevent the receptacle sliding off the hob because of these vibration movements, for example via the rims present on the support. In addition, preferably, the support does not rest directly on the insulating plate but is held above the plate by the fixing system, which allows certain degrees of freedom to the support.

The heating device may also comprise a frame forming the casing of the global heating device. This frame may be made from metal material and may be connected to the reference potential. Because of this, when the support is made from metal material, the support may be connected to the frame via an arm extending from the frame to the support.

In other words, this frame may be assimilated to the base described in one of the embodiments described previously, in which the rims of the base may form the casing of the heating device, except that the recess extends well beyond the heating area and encompasses the heating area or areas and any surface of the insulating plate that can be used by the user.

For example, the heating device may comprise several inductor systems defining several heating areas, a support being placed on the insulating plate at each heating area.

Each support may be made from metal material and connected to the reference potential. For example, each of the metal supports may be connected to the reference potential via an arm secured to the casing. It is also possible to connect one of the supports via an arm to the casing and to connect the other supports to this support.

Obviously the fitting of a temperature sensor and/or a weight measurement module is possible, and may be achieved as described previously. The temperature sensor makes it possible for example to better regulate the heating temperature in order to guarantee both optimum cooking and a temperature suited to the insulating plate.

### BRIEF DESCRIPTION OF THE DRAWINGS

Other features and advantages of the invention will emerge clearly from the description that is given thereof below, by way of indication and in no way limitatively, with reference to the accompanying figures, in which:

FIG. 1, described previously, is a schematic plan view of an induction heating device of the prior art;

FIG. 2, described previously, is a schematic view of the device of FIG. 1 shown in section along the plane A-A in FIG. 1;

FIG. 3 is a schematic plan view of an induction heating device according to one embodiment of the invention;

FIG. 4 is a schematic view of the device according to FIG. 3 shown in section along the plane B-B in FIG. 3;

FIG. 5 is a schematic view of the device according to another embodiment shown in section along the plane B-B in FIG. 3;

FIGS. 6 and 7 are schematic plan views of a support according to embodiments of the invention;

FIG. 8 is a schematic perspective view of the profile of part of an arm of the support according to one embodiment of the invention;

FIG. 9 is a schematic plan view of an induction heating device according to another embodiment of the invention;

FIG. 10 is a schematic view of the device according to FIG. 9 shown in section along the plane C-C in FIG. 9;

FIG. 11 is a schematic plan view of an induction heating device according to another embodiment of the invention; and

FIG. 12 is a schematic view of the device according to FIG. 11 shown in section along the plane D-D in FIG. 11.

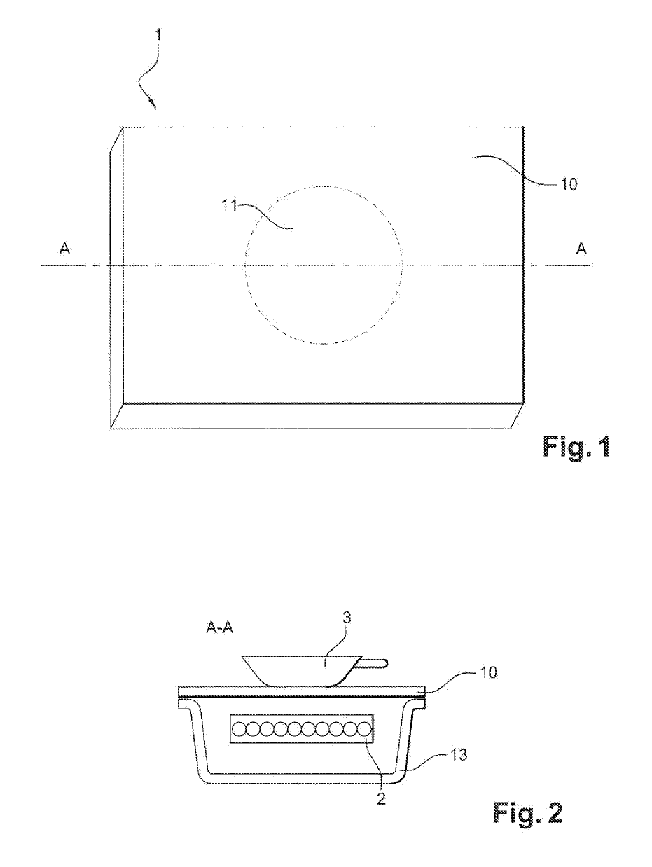

### DETAILED DESCRIPTION OF THE INVENTION

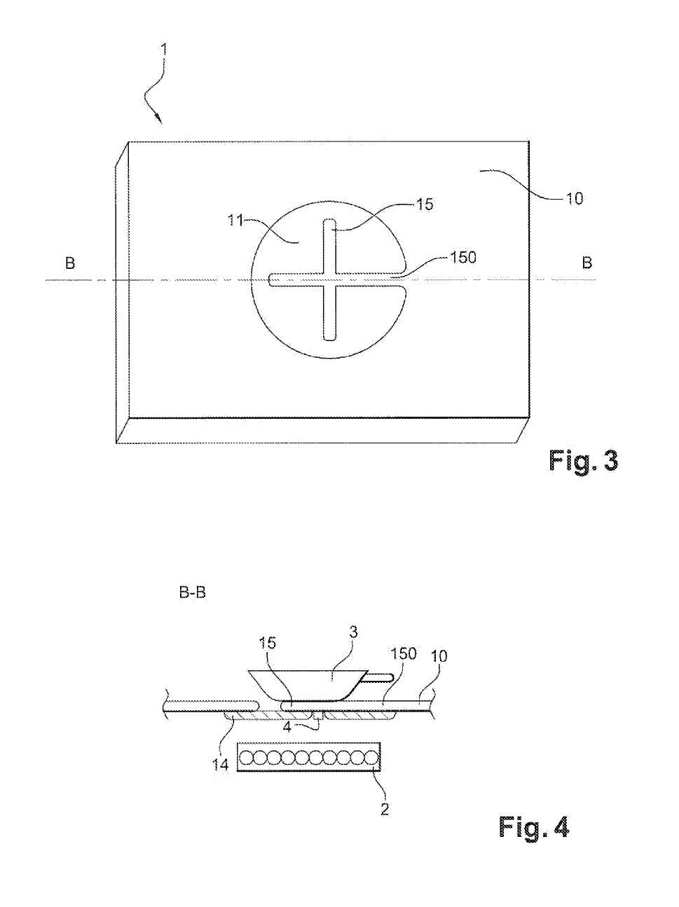

With reference to FIGS. 3, 4 and 5, the induction heating device 1 comprises a base 10 having a recess delimiting the heating area 11, and inside which a support 15 is arranged, intended to hold in a stable manner a receptacle 3 placed in the heating area. The support has a portion 150 in contact with the edge of the recess in the base 10. A non-magnetic electrically insulating plate 14 is arranged at the recess so as to extend over the entire surface of the recess forming a heating area 11, and the support rests on this non-magnetic electrically insulating plate 14. The sealing of the assembly consisting of base, support and non-magnetic electrically insulating plate can be achieved by means of a gasket and/or a bevelled shape of the periphery of the recess. The non-magnetic electrically insulating plate 14 has a recess in which a temperature sensor 4 is arranged, the sensitive part of which is in contact with the support 15. An inductor 2 is placed under the base 10 opposite the heating area 11.

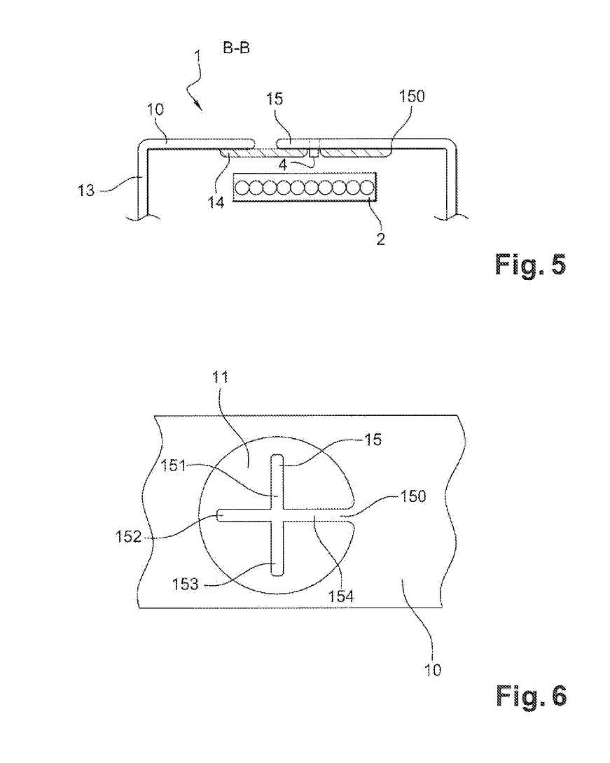

The base 10 and the support 15 are produced from a metal material that is non-magnetic or not, and preferably resistant to impacts, to abrasion due to the rubbing of receptacles, and to the high temperatures that may be reached during heating. It may advantageously be stainless steel, preferably austenitic. In addition, as illustrated partially in FIG. 5, the rims of the base 10 form a casing 13 of the global heating device. It is possible to form the casing 13 and the base 10 from a stainless steel plate, by pressing, and to produce the support 15 by cutting this metal plate. For example, a press tool may make it possible to produce such a piece in a single operation.

When the receptacle 3 arranged inside the heating area 11 is heated, the support 15 not extending over the entire heating area 11, the transfer of heat from the receptacle 3 to the support 15 is limited. Likewise, the support 15 being in contact with the base 10 only by means of a portion 150, the transfer of heat from the support 15 to the base 10 is also limited.

The support 10 holds the receptacle 3 in a stable manner above the recess in the base 10 and isolates the non-magnetic and electrically insulating plate 14 from any contact with the receptacle 3. The non-magnetic electrically insulating plate 14 therefore does not undergo the impacts and abrasions due to the rubbing of the receptacles, the mechanical stresses being transferred to the support 15. Consequently a less thick material, less resistant to impacts and abrasions, and less expensive, for example stoneware or ceramic, may be used for producing the non-magnetic electrically insulating plate 14.

This particular configuration of the assembly formed by the base 10, the support 15 and the non-magnetic electrically insulating plate 14 allows the combination of various materials other than vitroceramic, and makes it possible to reduce the dimensions of the air gap formed between the inductor 14 and the receptacle 3. Efficiency is thus improved and the costs of manufacturing the inductor as well as the electromagnetic leakages are reduced. For example, the thickness formed by that of the non-magnetic electrically insulating plate 14 combined with that of the support 15 may be less than or equal to five millimetres. In addition, the combination of various materials makes it possible to visually differentiate the induction heating device from conventional radiant heating devices. The invention thus offers novel possibilities, in particular aesthetic, making it possible to offer high-end heating devices by virtue in particular of the use of stainless steel, or ones intended for professionals. The integration of the heating devices in stoves or on top of cookers is also made possible.

Moreover, the use of a metal material, in particular for the support 15, allows a more precise measurement of the temperature representing that of the receptacle 3. The use of an identical metal material for the support 15 and base 10 facilitates the manufacture of the induction heating device 1. This eliminates the electrical discharges liable to pass through the body of a person touching the receptacle, the portion 150 of the support 15 in contact with the base 10 connecting the receptacle to earth. In addition, the electromagnetic leakages by radiation are reduced since the support covered by the receptacle, the base and the casing form a quasi-closed box similar to a quasi Faraday cage.

In another embodiment, the non-magnetic electrically insulating plate 14 can be produced by moulding onto the support 15 and the temperature sensor 4. In addition, this non-magnetic electrically insulating plate 14 is optional since the inductor 2 has a mechanically sufficiently strong top surface on which the support 15 can be placed directly. In this particular embodiment, the sealing of the assembly formed by the surface of the inductor, the support and the base can be achieved by means of suitable gaskets. For example, cleaning the heating device is made easier by producing a gentle transition between the different materials used.

The choices of the shape and size of the support 15 result in particular from a compromise that makes it possible to hold the receptacle in a stable manner above the recess, to measure the temperature of the receptacle precisely, and this even if the receptacle has a deformed bottom, while limiting the contact surface between the support and the receptacle in order to reduce the heat transfers from the receptacle to the support 15 and base 10.

In general terms, the geometry of the support can be the result of a compromise between:
a sufficient surface for holding the receptacle above the recess, so that the smallest receptacle usable does not touch the non-magnetic electrically insulating plate, even if the bottom of the receptacle has deformations;
a cut surface having a minimum of coupling with the inducing magnetic field in order to prevent the support being the origin of excessively high induced currents;
a minimum contact surface for limiting the exchanges of heat with the receptacle; and
optimised surface and thermal inertia to ensure optimum heat transfer to the temperature sensor associated therewith.

For example, the support 15 may comprise a first star-shaped portion having a plurality of arms, the free end of one of the arms being secured to the base. In this configuration, the receptacle can be kept stable, and the contact surface of the support with the receptacle is limited, improving the efficiency, and the heat transmitted by the receptacle to the support can be distributed evenly over the support whatever the shape of the bottom of the receptacle, improving the precision of the temperature measurement.

With reference to FIG. 6, the support 15 has four arms 151, 152, 153, 154 distributed in a cross, and the free end 150 of one of the four arms is secured to the base 10.

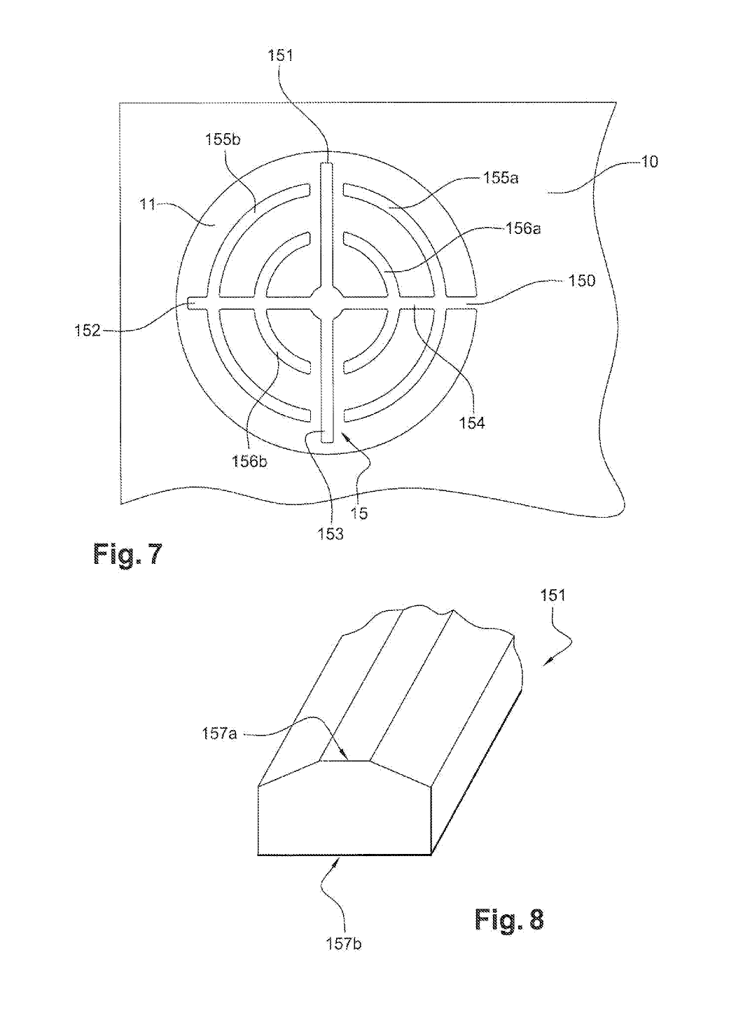

With reference to FIG. 7, the support 15 has a first portion formed by four arms 151, 152, 153, 154 distributed in a cross, and the free end 150 of one of the four arms is secured to the base 10. The support also has second, third, fourth and fifth portions 155a, 155b, 156a, 156b in an arc of a circle, the second and third portions 155a, 155b having a length greater than the fourth and fifth portions 156a, 156b. The second and third portions 155a, 155b are arranged opposite each other symmetrically with respect to two arms 151, 153 of the first portion. The fourth and fifth portions 156a, 156b are also arranged opposite each other symmetrically with respect to the two arms 151, 153 of the first portion. This particular cutout, which has a larger surface, offers, in addition to the advantages cited previously, the advantage of minimising the electromagnetic repulsion force possibly generated during the heating of a receptacle made from conductive non-magnetic material such as copper, stainless steel or aluminium. This is because the induced currents flowing in a conductive non-magnetic receptacle create a magnetic field that is opposed to that created by the inductor system, thereby repelling the receptacle being heated. This repulsion force is proportional approximately to the surface of the heating area, as well as to the heating power supplied. By interposing a non-magnetic element, here the austenitic stainless steel support, between the inductor and the receptacle, part of this repulsion force is exerted on the support without however generating excessive induced currents in the support, because of the particular geometric shape of the support, which minimises these induced currents. The heating of the non-ferritic receptacle can also be optimised. For example, by minimising the air gap and using supports having particular cutouts (or geometric shapes) in order to optimise the impedance of the inductor system in its environment in the presence of the non-ferritic receptacle.

In addition, making junctions between the support and the base and producing a support the geometry of which has one or more closed loops will be avoided, in order to limit the flow of induced currents.

With reference to FIG. 8, the profile of each arm 151, 152, 153, 154 may have an upper base 157a intended to be in contact with the receptacle 3 and a lower base 157b opposite the upper base 157a, the upper base 157a having a length less than that of the lower base 157b. This profile has in particular the advantage of reducing the contact surface of the support with the receptacle in order to limit heat transfers, while ensuring stable holding of the receptacle and even distribution of the heat for the temperature measurement.

Moreover, the distribution of the heat being even on the support 15, the temperature sensor 4, for example a thermocouple or a thermistance with a negative temperature coefficient (or NTC), which may be positioned under the star, for example at the centre of the star, namely at the meeting point between the arms, can measure a temperature very close to the actual temperature of the receptacle.

The induction heating device can also comprise a system for regulating the temperature of the receptacle. This is because better knowledge of the temperature of the receptacle makes it possible to control precisely the functions such as boiling, browning and simmering, and makes it possible to fix a lower maximum temperature in order to avoid overheating and to allow the use of materials with lower heat resistance.

A heating device comprising a heating area was described previously, but it is of course possible to provide, for an induction heating device, a plurality of heating areas having the features described above.

In addition, the shape of the heating area may be round, but may also be of various shapes and sizes, for example rectangles or oblongs, or adapted to be used with a multitude of inductors.

It is therefore clear from the above that the combination of two materials for producing the base of the support and the non-magnetic electrically insulating plate makes it possible to settle various problems related to the use of vitroceramic.

The reduction in the dimensions of the air gap makes it possible to use coils containing fewer turns, increases coupling, and reduces the manufacturing cost and electromagnetic leakages.

The choice of the shape and size of the support according to the criteria presented above firstly enables the receptacle, even having a deformed bottom, to be continuously in contact with the support, and secondly enables the temperature to be distributed uniformly over the support, thus affording better measurement of the temperature.

The more precise measurement of the temperature offers the possibility of achieving good thermal regulation, in place of or in addition to the traditional power regulations, as well as the use of materials less resistant to high temperatures and less expensive.

The heating device can also be provided with additional functions such as for example a weighing function. For this purpose, the heating device can comprise a weight measurement module such as a piezoelectric sensor associated with a signal acquisition and processing module. The piezoelectric sensor can be arranged between the support and the insulating plate, or in another way in the device, in so far as there exists a mechanical connection (for example a shaft) able to transmit any mechanical deformation from the support to the weight measurement module.

In order to ensure minimum but sufficient deformation of the support in order to act on the piezoelectric sensor, in particular when a receptacle is arranged on the support, the support can be assembled in a flexible fashion. For example, a temperature-resistant silicone gasket can be disposed between the support and the insulating plate.

The device can also be provided with an automatic cooking function, namely for example automatic stoppage of the cooking according to the type of food to be cooked and the weight detected. For this purpose, the device can also be provided with a control module that determines the heating power adapted as well as the end or duration of the cooking according to data entered by the user, such as for example an indication of the cooking method or the type of food to be cooked (sauces, roasts, fish, vegetables, pasta, etc), and according to the pre-cooking weight and the weight detected during cooking.

For easy cleaning of the assembly, it is possible to enlarge the recess, that is to say the recess encompasses both the heating area or areas and any surface of the insulating plate that can be used by the user. Nooks in which dirt is liable to be encrusted are therefore reduced.

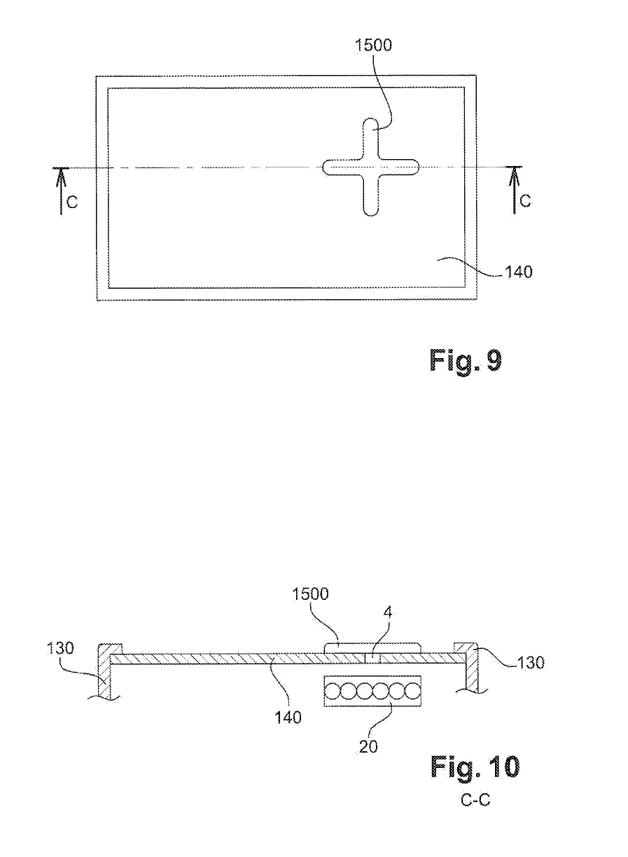

Thus, in another embodiment illustrated in FIGS. 9 and 10, the induction heating device can comprise in particular:
an inductor 20 defining a heating area;
a support 1500, for example made from metal material, for a receptacle arranged vertically in line with the inductor 20, having for example the form of a cross;
a non-magnetic electrically insulating plate 140 arranged between the support 1500 and the inductor 20, the support 1500 resting on the said insulating plate 140; and
a frame 130, for example made from metal material, forming the casing of the global heating device, and connected to the reference potential.

The support 1500 can be connected to the frame 130 via an arm extending from the frame to the support, in order to ensure safety of the user.

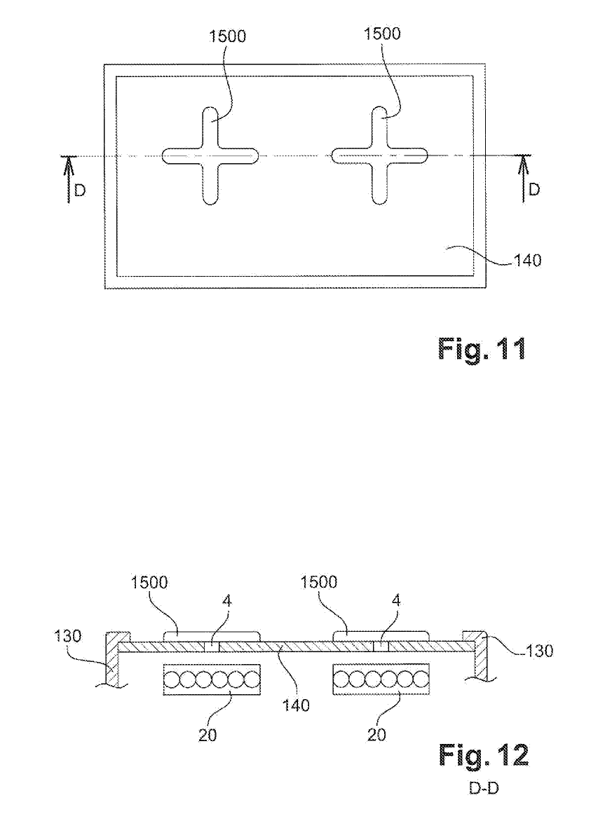

For example, as illustrated in FIGS. 11 and 12, the heating device comprises:
supports 1500 for receptacles, each being arranged vertically in line with an inductor 20 defining a heating area;
the non-magnetic electrically insulating plate 140 arranged between the supports 1500 and the inductors 20, the supports 1500 resting on this insulating plate 140; and
the frame 130 forming the casing of the global heating device, and connected to the reference potential.

As can be seen, in this other embodiment, the frame 130 can be assimilated to the base of the one of the embodiments previously described, in which the rims of the base can form the casing of the heating device, except that the recess extends well beyond the heating area and encompasses the heating area or areas and any surface of the insulating plate usable by the user.

Obviously the fitting of a temperature sensor and/or a weight measurement module is possible, and can be achieved as described previously. The temperature sensor makes it possible for example to better regulate the heating temperature in order to guarantee both optimum cooking and a temperature suited to the insulating plate.

Thus the solution of the invention makes it possible in particular to reduce manufacturing costs, to offer a device offering better resistance to impacts, to abrasion and to high temperatures by virtue in particular of the use of stainless steel, to reduce the air gap between the inductor and the receptacle, to know precisely the temperature of the receptacles, to increase the energy efficiency, and to eliminate any electrical discharges that might be felt by the user when touching the receptacle being heated.

In addition, the possibility of using materials other than vitroceramic makes it possible to offer high-end induction heating devices differentiated from conventional radiant element heating devices intended for the general public or professionals. The possibility of combining different materials with varied shapes, sizes and colours, offers in particular novel aesthetic possibilities that make it possible to visually differentiate the induction heating device of the invention from the traditional induction or radiant heating devices. By virtue of the invention, which allows in particular the use of stainless steel, it is now possible to offer high-end induction heating devices. Finally, it is possible to integrate, in the support shapes, design elements for visually differentiating heating areas in order to identify them either with a make or a particular model.

1. An induction heating device comprising at least one base having at least one heating area, and at least one inductor arranged under the base opposite the heating area, characterised in that the base comprises a recess delimiting the heating area and inside which a support is arranged partially covering said heating area and partially secured to the base, said support being adapted to support a receptacle so as to hold said receptacle above the recess.

2. The device according to claim 1, characterised in that the base and the support are made from metal materials.

3. The device according to claim 1 characterised in that said device further comprises a plate made from non-magnetic electrically insulating material, extending over the entire heating area, and on which the said support rests.

4. The device according to claim 2, characterised in that said device further comprises at least one temperature sensor, a sensitive part of which is in contact with the support.

5. The device according to claim 3, characterised in that the non-magnetic electrically insulating plate has at least one recess in which at least one temperature sensor is arranged, a sensitive part of which is in contact with the support.

6. The device according to claim 3, characterised in that the non-magnetic electrically insulating plate is moulded onto the support and onto at least one temperature sensor, a sensitive part of which is in contact with the support.

7. The device according to claim 1, characterised in that the support is in the form of a star having a plurality of arms, a free end of at least one of said arms being secured to the base.

8. The device according to claim 1, characterised in that the support has at least one first cruciform portion, a free end of at least one arm of the said portion being secured to the base.

9. The device according to claim 8, characterised in that the support also has at least second and third portions in an arc of a circle, arranged opposite each other symmetrically with respect to at least one of the arms of the said first portion.

10. The device according to claim 1, characterised in that the support is in the form of a star, a profile of each arm of the said support having a top base adapted to be in contact with the receptacle and a bottom base opposite said top base, said top base having a length less than that of the bottom base.

11. The device according to claim 3, characterised in that a thickness formed by that of the non-magnetic plate combined with that of the support is less than or equal to five millimetres.

12. The device according to claim 4, characterised in that the temperature sensor is opposite a centre of the support.

13. The device according to claim 1, characterised in that rims of the base form a frame of the heating device.

14. The device according to claim 1, characterised in that the base is connected to a reference potential.

15. The device according to claim 1, characterised in that said device further comprises a system for regulating the temperature of the receptacle.

16. The device according to claim 1, characterised in that said device further comprises a visual device that is a function of a temperature of the support.

17. The device according to claim 1, characterised in that said device further comprises a module for measuring the weight of an object placed on the support.

18. The device according to claim 17, characterised in that said device further comprises a regulation and protection module adapted to, from a measurement of a weight of the receptacle, regulate a maximum heating power.

19. The device according to claim 1, characterised in that the base is also provided with reliefs adapted to hold or receive accessories of an electrical or mechanical type.
